(19) United States
(12) Patent Application Publication
(10) Pub. No.: US 2009/0296862 A1
(43) Pub. Date: Dec. 3, 2009

(54) RECEIVING APPARATUS AND RECEIVING METHOD

(75) Inventor: Yuuta Nakaya, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/356,688

(22) Filed: Jan. 21, 2009

(30) Foreign Application Priority Data
May 30, 2008 (JP) 2008-143123

(51) Int. Cl. H04L 27/06

(52) U.S. Cl. 375/343

(57) ABSTRACT

A receiving apparatus that can properly determine the position of an effective symbol included in a received signal is provided. A receiver acquires a signal from a sending apparatus that transmits a signal into which a guard interval which is a replica of at least part of an effective symbol is inserted between the effective symbol and another effective symbol. A timing detector finds a correlation between the received signal and a signal obtained by shifting the received signal in a time direction, detects timing at which a maximum correlation value is obtained, and determines that timing which is predetermined time (>0) away from the timing detected is a position of an effective symbol included in the received signal.

### CROSS-REFERENCE TO RELATED APPLICATIONS

This application is based upon and claims the benefits of priority from the prior Japanese Patent Application No. 2008-143123, filed on May 30, 2008, the entire contents of which are incorporated herein by reference.

### BACKGROUND OF THE INVENTION

(1) Field of the Invention

This invention relates to a receiving apparatus and a receiving method. For example, this invention is applicable to a receiving apparatus and a receiving method for receiving a signal into which a guard interval is inserted.

(2) Description of the Related Art

At present radio communication systems, such as cellular phone systems and wireless local area networks (LANs), are widely used. In some radio communication systems, a guard interval is inserted between effective symbols which are units of predetermined signal processing (modulation and demodulation, for example) when the effective symbols are radio-transmitted. The guard interval will now be described with an orthogonal frequency division multiplexing (OFDM) radio communication system as an example. The OFDM is one of multicarrier transmission modes.

The following can be considered as an example of the OFDM radio communication system. A sending apparatus associates transmitted data with a plurality of subcarriers. Then the sending apparatus converts frequency domain signals to a time domain signal by performing a transform, such as an inverse fast Fourier transform (IFFT), to obtain an effective symbol in which components of the plurality of subcarriers are multiplexed. After that, the sending apparatus adds a guard interval which is a replica of at least part of the effective symbol to the effective symbol, and radio-transmits them as a symbol.

A receiving apparatus estimates the position (timing on a time axis) of the effective symbol included in a signal received from the sending apparatus, and extracts a signal corresponding to effective symbol length from the received signal. Then the receiving apparatus converts the time domain signal to frequency domain signals by performing a transform, such as a fast Fourier transform (FFT). After that, the receiving apparatus restores the original transmitted data on the basis of the frequency domain signals obtained.

As stated above, the sending apparatus inserts a guard interval between effective symbols and the receiving apparatus removes the guard interval and performs demodulation and decoding. By doing so, the influence of multipath can be reduced. That is to say, the receiving apparatus may receive a radio wave in which a preceding wave (for example, a radio wave which directly reaches the receiving apparatus from the sending apparatus) and a delayed wave (for example, a radio wave which is reflected from an object such as a building and which reaches the receiving apparatus after the preceding wave) overlap. If a delay amount of the delayed wave is smaller than or equal to the time length of the guard interval, then the overlapping of different effective symbol signals on the time axis can be avoided. This suppresses a deterioration in the accuracy of the demodulation and decoding.

For example, the following techniques are known regarding timing detection by a receiving apparatus. A method for finding a correlation in the frequency domain between a known signal and a signal which is extracted from a received signal and which corresponds to the known signal and for determining the timing of a Fourier transform on the basis of the correlation found is proposed (see, for example, International Publication No. 2003/094399 (pamphlet) and Published Japanese Translation of a PCT Application No. 2005-506757). In addition, a method for finding a correlation in the frequency domain between two consecutive symbols after symbol timing synchronization and for specifying frame timing on the basis of the correlation found is proposed (see, for example, Japanese Laid-Open Patent Publication No. 2007-88713).

It is assumed that the receiving apparatus detects the timing of an effective symbol in the time domain (that is to say, by the use of a received signal which is not yet converted to the frequency domain). The receiving apparatus finds a correlation between the received signal and a signal obtained by shifting the received signal in a time direction (for example, a signal obtained by delaying the received signal by effective symbol length). By doing so, the receiving apparatus can estimate the position of the effective symbol. A guard interval is a replica of a signal included in the effective symbol, so a maximum correlation value is obtained at a position where the guard interval and the signal included in the effective symbol overlap. Accordingly, the receiving apparatus can determine the position of the effective symbol (for example, a position at which the effective symbol starts) from timing at which the maximum correlation value is obtained.

### SUMMARY OF THE INVENTION

According to one aspect of the invention, a receiving apparatus comprising a receiver for acquiring a signal from a sending apparatus that transmits a signal into which a guard interval which is a replica of at least part of an effective symbol is inserted between the effective symbol and another symbol and a timing detector for finding a correlation between the received signal acquired by the receiver and a signal obtained by shifting the received signal in a time direction, for detecting timing at which a maximum correlation value is obtained, and for determining that timing which is predetermined time (>0) away from the timing detected is a position of an effective symbol included in the received signal is provided.

According to another aspect of the invention, a receiving method comprising the steps of acquiring a signal from a sending apparatus that transmits a signal into which a guard interval which is a replica of at least part of an effective symbol is inserted between the effective symbol and another effective symbol, and finding a correlation between the received signal acquired and a signal obtained by shifting the received signal in a time direction, detecting timing at which a maximum correlation value is obtained, and determining that timing which is predetermined time (>0) away from the timing detected is a position of an effective symbol included in the received signal is provided.

According to yet another aspect of the invention, a receiving apparatus comprising a receiver for acquiring a signal from a sending apparatus that transmits a signal into which a guard interval which is a replica of at least part of an effective symbol is inserted between the effective symbol and another effective symbol, a timing detector for finding a correlation between the received signal acquired by the receiver and a signal obtained by shifting the received signal in a time direction and for detecting timing at which a maximum correlation value is obtained, and an effective symbol extractor for finding an extraction interval in which an effective symbol length signal is extracted from the received signal on the basis of a result detected by the timing detector and for replacing a signal with predetermined length at an end of the extraction interval with a signal with the predetermined length which appears before the extraction interval is provided.

According to still another aspect of the invention, a receiving method comprising the steps of acquiring a signal from a sending apparatus that transmits a signal into which a guard interval which is a replica of at least part of an effective symbol is inserted between the effective symbol and another effective symbol, finding a correlation between the received signal acquired and a signal obtained by shifting the received signal in a time direction and detecting timing at which a maximum correlation value is obtained, and finding an extraction interval in which an effective symbol length signal is extracted from the received signal on the basis of a result of the timing detection and replacing a signal with predetermined length at an end of the extraction interval with a signal with the predetermined length which appears before the extraction interval is provided.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for giving an overview of a receiving apparatus according to a first embodiment of the present invention.

FIG. 2 is a view showing a communication system according to a first embodiment of the present invention.

FIG. 3 is a block diagram showing a sending apparatus according to a first embodiment of the present invention.

FIG. 4 is a block diagram showing a receiving apparatus according to a first embodiment of the present invention.

FIG. 5 is a view showing an example of the structure of a frame used in the communication system according to the first embodiment of the present invention.

FIGS. 6A and 6B are views showing an example of the structure of a symbol used in the communication system according to the first embodiment of the present invention.

FIG. 7 is a flow chart showing a procedure for a receiving process performed in the receiving apparatus according to the first embodiment of the present invention.

FIG. 8 is a view showing a method for calculating a time correlation in the receiving apparatus according to the first embodiment of the present invention.

FIG. 9 is a view showing a method for calculating a frequency correlation in the receiving apparatus according to the first embodiment of the present invention.

FIG. 10 is a view showing an example of the result of effective symbol extraction performed in the receiving apparatus according to the first embodiment of the present invention.

FIG. 11 is a view for giving an overview of a receiving apparatus according to a second embodiment of the present invention.

FIG. 12 is a block diagram showing a receiving apparatus according to the second embodiment of the present invention.

FIG. 13 is a flow chart showing a procedure for a receiving process performed in the receiving apparatus according to the second embodiment of the present invention.

FIG. 14 is a view showing an example of the result of effective symbol extraction performed in the receiving apparatus according to the second embodiment of the present invention.

FIG. 15 is a block diagram showing a receiving apparatus according to a third embodiment of the present invention.

FIG. 16 is a flow chart showing a procedure for a receiving process performed in the receiving apparatus according to the third embodiment of the present invention.

FIG. 17 is a view showing an example of the result of effective symbol extraction performed in the receiving apparatus according to a third embodiment of the present invention.

### DESCRIPTION OF THE PREFERRED EMBODIMENTS

### First Embodiment

With a method for detecting timing of the effective symbol in the time domain, a receiving apparatus makes an error in determining the position of the effective symbol if a method for inserting the guard interval into the received signal differs from a method which the receiving apparatus estimates. For example, it is assumed that many of ordinary sending apparatus adopt the method of making a replica of a last predetermined length portion of an effective symbol and adding the replica to the head of the effective symbol and that a sending apparatus adopts an irregular method (which differs from the above general method in that a replica of another portion of an effective symbol is made, for example). With a received signal into which a guard interval is inserted according to the general method, the position of an effective symbol is determined from timing at which a maximum correlation value is obtained. However, applying the same way to a received signal into which a guard interval is inserted according to an irregular method results in an erroneous determination.

If a signal is extracted at an erroneous position, phase rotation occurs in frequency domain signals after conversion. This causes a deterioration in the accuracy of a demodulation and decoding process performed later.

A first embodiment of the present invention will now be described in detail with reference to the drawings.

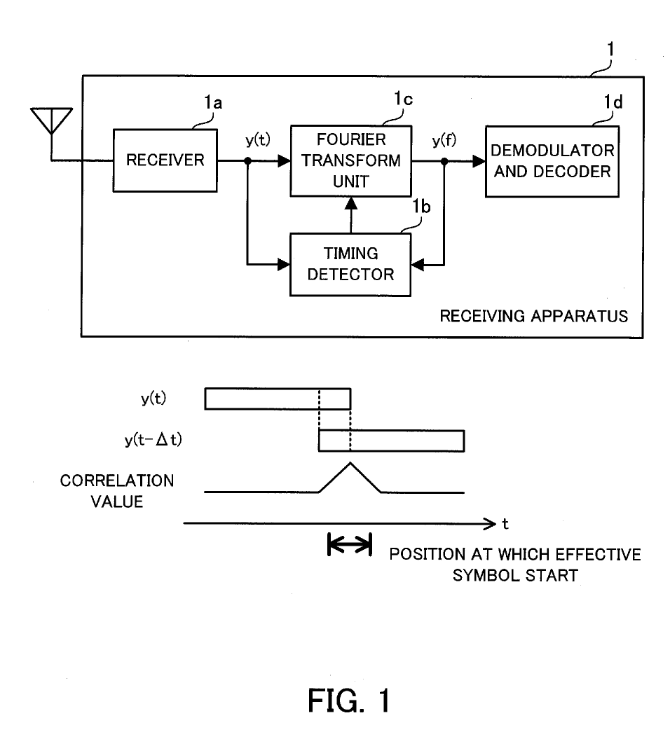

FIG. 1 is a view for giving an overview of a receiving apparatus according to a first embodiment of the present invention. A receiving apparatus 1 comprises a receiver 1a, a timing detector 1b, a Fourier transform unit 1c, and a demodulator and decoder 1d.

The receiver 1a acquires a signal from a sending apparatus which transmits a signal including effective symbols and guard intervals. An effective symbol is a unit of predetermined signal processing, such as modulation and demodulation. A guard interval is inserted between effective symbols by the sending apparatus and is a replica of at least part of an effective symbol.

The timing detector 1b determines a position of an effective symbol on the basis of the received signal acquired by the receiver 1a and informs the Fourier transform unit 1c of the position. To be concrete, the timing detector 1b finds a correlation in the time domain between the received signal and a signal obtained by shifting the received signal in the time direction (for example, a signal obtained by delaying the received signal by effective symbol length Δt) and detects timing at which a maximum correlation value is obtained. Then the timing detector 1b determines that timing which is predetermined time (>0) away from the detected timing is the position of the effective symbol.

The Fourier transform unit 1c removes the guard interval from the received signal acquired by the receiver 1a on the basis of the notice sent from the timing detector 1b, and extracts a signal having the effective symbol length. Then the Fourier transform unit 1c converts the extracted time domain signal to frequency domain signals by the use of, for example, an FFT. However, a conversion algorithm other than an FFT may be used.

The demodulator and decoder 1d acquires the frequency domain signals from the Fourier transform unit 1c and performs a demodulation and decoding process. For example, the demodulator and decoder 1d performs channel estimation, channel compensation, a demodulation process, and an error correction decoding process. As a result, data transmitted by the sending apparatus is restored.

In this case, the timing detector 1b finds a correlation in the time domain, detects timing, and determines timing at which the effective symbol is extracted by the use of the detected timing. However, the timing detector 1b does not consider the detected timing as extraction timing. That is to say, the timing detector 1b can consider timing obtained by correcting the detected timing as extraction timing.

For example, it is assumed that the method of making a replica of 128 last samples of an effective symbol and adding the replica to the head of the effective symbol as a guard interval is adopted in many of prevailing sending apparatus. On the other hand, it is assumed that the irregular method of making a replica of 64 last samples of an effective symbol and adding the replica to the head of the effective symbol, and making a replica of 64 first samples of the effective symbol and adding the replica to the end of the effective symbol is adopted in a sending apparatus.

Both in the cases of the above general method and irregular method, the timing detector 1b may detect that timing at which a maximum correlation value is obtained comes 128 samples after the head of a symbol. With a received signal into which a guard interval is inserted according to the general method, the detected timing indicates a correct position at which an effective symbol starts. With a received signal into which a guard interval is inserted according to the irregular method, on the other hand, the detected timing does not indicate a correct position at which an effective symbol starts. Correctly, an effective symbol starts 64 samples after the head of the symbol.

In addition, a sending apparatus may perform a time filtering process on a symbol signal into which a guard interval has been inserted. If a time filtering process has been performed, a maximum correlation value is not detected definitely (peak becomes low) at the time of finding a correlation in the time domain. This may produce an error in the determination of the timing of an effective symbol.

Therefore, the timing detector 1b can determine that timing which is predetermined time (>0) away from timing at which the maximum correlation value is detected is the position of the effective symbol. That is to say, the timing detector 1b can make a correction by shifting the timing which is obtained by finding a correlation in the time domain by time which is not 0 (zero). The predetermined time can be determined by the following method in which a frequency domain signal, for example, outputted from the Fourier transform unit 1c is used.

First the timing detector 1b finds a first signal obtained by dividing a frequency domain signal which is obtained from the Fourier transform unit 1c and which corresponds to a known signal by a known frequency domain signal. Then the timing detector 1b finds a second signal obtained by shifting the first signal in the frequency direction by a predetermined frequency (for example, a frequency corresponding to a spacing between subcarriers). The timing detector 1b finds a correlation between the first signal and the second signal. The amount of phase rotation caused by an error in timing detection can be found from a correlation value and the amount of a timing correction can be calculated from a phase rotation amount. The reason for the ability to correct timing by this method will be described later in detail.

With the receiving apparatus 1 having the above structure, the receiver 1a acquires a signal in which a guard interval that is a replica of at least part of an effective symbol is inserted between the effective symbol and another effective symbol. The timing detector 1b detects timing at which there is a maximum correlation between the received signal and a signal obtained by shifting the received signal in the time direction. The timing detector 1b determines that timing which is predetermined time (>0) from the timing detected is the position of the effective symbol. The predetermined time can be found by the use of, for example, a frequency domain signal obtained from the Fourier transform unit 1c.

As a result, the receiving apparatus 1 can properly determine the position of an effective symbol. That is to say, the receiving apparatus 1 can flexibly communicate with a sending apparatus using an irregular method for inserting a guard interval by correcting timing obtained by detecting a correlation in the time domain. In addition, the receiving apparatus 1 can flexibly communicate with a sending apparatus which performs a time filtering process on a symbol signal. This avoids situations under which the receiving apparatus 1 cannot communicate at all with some sending apparatus (which are not based on the communication standards, for example) or situations under which a transmission rate significantly drops, and contributes to the improvement of the quality of a communication system.

A communication system according to a first embodiment of the present invention will now be described in detail.

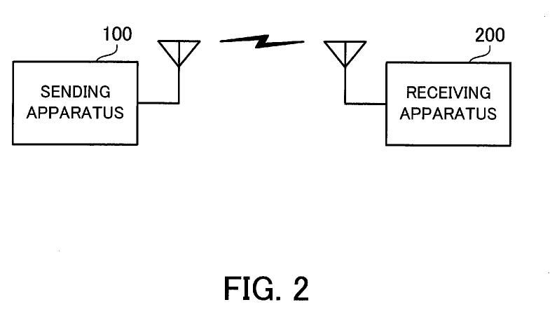

FIG. 2 is a view showing a communication system according to a first embodiment of the present invention. This communication system includes a sending apparatus 100 and a receiving apparatus 200. The sending apparatus 100 encodes and modulates data and outputs the data as a radio signal. The receiving apparatus 200 receives the radio signal transmitted by the sending apparatus 100 and restores the data by performing demodulation and decoding.

With downlink communication, the sending apparatus 100 corresponds to, for example, a radio base station and the receiving apparatus 200 corresponds to, for example, a subscriber station such as a cellular phone. With uplink communication, the sending apparatus 100 corresponds to a subscriber station and the receiving apparatus 200 corresponds to a radio base station. With two-way link communication, a communication system may include a radio base station and a subscriber station each of which functions both as the sending apparatus 100 and as the receiving apparatus 200.

For the sake of simplicity only the sending function of the sending apparatus 100 and only the receiving function of the receiving apparatus 200 will now be described. Descriptions of functions other than the detection of the timing of an effective symbol will be omitted at need. It is assumed that the sending apparatus 100 and the receiving apparatus 200 use the OFDM as a communication mode.

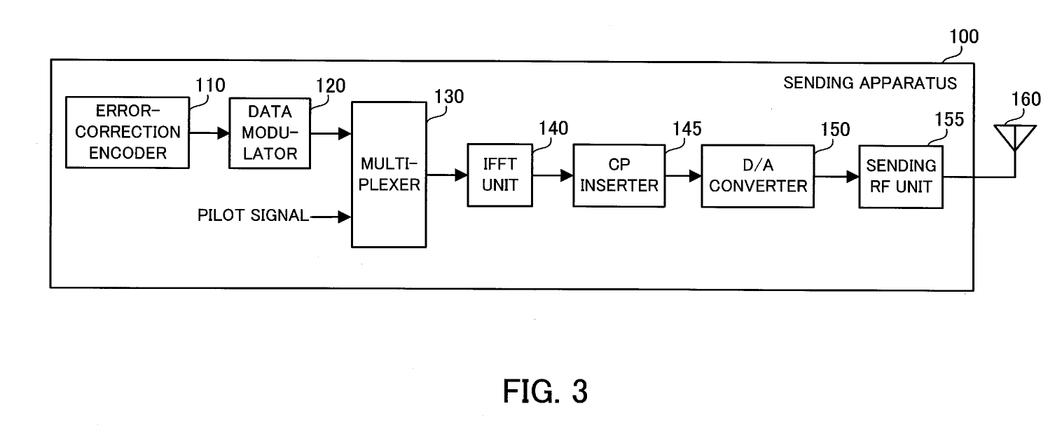

FIG. 3 is a block diagram showing a sending apparatus according to a first embodiment of the present invention. The sending apparatus 100 includes an error-correction encoder 110, a data modulator 120, a multiplexer 130, an IFFT unit 140, a cyclic prefix (CP) inserter 145, a digital-to-analog (D/A) converter 150, a sending radio frequency (RF) unit 155, and an antenna 160.

When data to be transmitted to the receiving apparatus 200 is generated, the error-correction encoder 110 performs an error-correction encoding process on the data to be transmitted. A turbo code, a convolutional code, or the like can be used for encoding. A fixed encoding mode set in advance may be used or a proper encoding mode may be selected according to the state of a transmission line. The error-correction encoder 110 outputs encoded data obtained to the data modulator 120.

The data modulator 120 digital-modulates the encoded data acquired from the error-correction encoder 110. Quadrature phase shift keying (QPSK), quadrature amplitude modulation (16 QAM), or the like can be used as a modulation mode. A fixed modulation mode set in advance may be used or a proper modulation mode may be selected according to the state of a transmission line. The data modulator 120 outputs a data signal after the modulation to the multiplexer 130.

The multiplexer 130 time-multiplexes the data signal after the modulation acquired from the data modulator 120 and a pilot signal (known signal) known to the receiving apparatus 200 in accordance with a predetermined pattern. Then the multiplexer 130 outputs a signal obtained to the IFFT unit 140.

The IFFT unit 140 performs an inverse fast Fourier transform on the signal acquired from the multiplexer 130. That is to say, the IFFT unit 140 associates the signal acquired from the multiplexer 130 with the subcarriers, considers the signal acquired as frequency domain signals, and converts the frequency domain signals to a time domain signal. The time domain signal obtained is an effective symbol having predetermined length. The IFFT unit 140 outputs the effective symbol obtained to the CP inserter 145. A transform algorithm other than an inverse fast Fourier transform may be used for converting the frequency domain signals to a time domain signal.

The CP inserter 145 inserts a guard interval called a CP between effective symbols acquired from the IFFT unit 140. The CP is a replica of at least part of a signal included in an effective symbol. Then the CP inserter 145 outputs a symbol including the effective symbol and the CP to the D/A converter 150. There are a plurality of possible methods of inserting a CP. A CP insertion method is set in advance in the CP inserter 145. A concrete example of a CP insertion method will be described later.

The D/A converter 150 converts discrete symbol signals (digital symbol signals) acquired from the CP inserter 145 to a continuous signal (analog signal). Then the D/A converter 150 outputs the signal obtained to the sending RF unit 155.

The sending RF unit 155 performs quadrature modulation on the signal acquired from the D/A converter 150 to convert a frequency band for internal processing in the sending apparatus 100 (frequency band for a base band signal) to a high frequency band for a radio signal. Then the sending RF unit 155 outputs a signal after the conversion to the antenna 160.

The antenna 160 is a sending antenna. The antenna 160 radio-transmits the signal acquired from the sending RF unit 155 to the receiving apparatus 200. If the sending apparatus 100 also has a receiving function, the sending apparatus 100 may include a receiving antenna in addition to the antenna 160 or the antenna 160 may be both for sending and for receiving. In the latter case, an antenna sharing device for separating a transmitted signal and a received signal can be connected to the antenna 160.

A time filtering process can be performed on the symbol signal into which the CP has been inserted between the CP inserter 145 and the D/A converter 150. By doing so, unnecessary frequency components outside a desired frequency band can be cut.

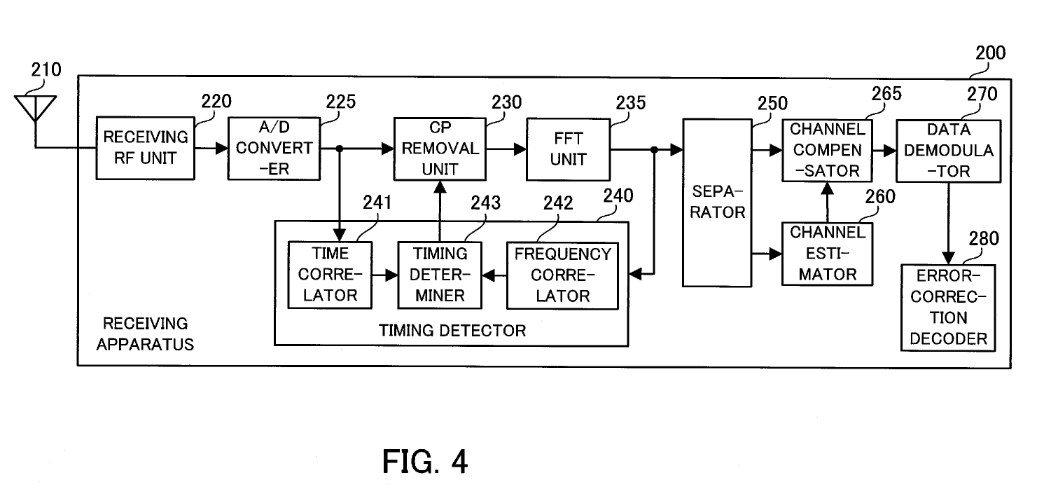

FIG. 4 is a block diagram showing a receiving apparatus according to a first embodiment of the present invention. The receiving apparatus 200 includes an antenna 210, a receiving RF unit 220, an analog-to-digital (A/D) converter 225, a CP removal unit 230, an FFT unit 235, a timing detector 240, a separator 250, a channel estimator 260, a channel compensator 265, a data demodulator 270, and an error-correction decoder 280.

The receiving RF unit 220 and the A/D converter 225 correspond to the receiver 1a shown in FIG. 1. The CP removal unit 230 and the FFT unit 235 correspond to the Fourier transform unit 1c shown in FIG. 1. The timing detector 240 corresponds to the timing detector 1b shown in FIG. 1. The separator 250, the channel estimator 260, the channel compensator 265, the data demodulator 270, and the error-correction decoder 280 correspond to the demodulator and decoder 1d shown in FIG. 1.

The antenna 210 is a receiving antenna. The antenna 210 receives the signal radio-transmitted by the sending apparatus 100 and outputs the radio signal to the receiving RF unit 220. If the receiving apparatus 200 also has a sending function, the sending apparatus 100 may include a sending antenna in addition to the antenna 210 or the antenna 210 may be both for sending and for receiving. In the latter case, an antenna sharing device for separating a received signal and a transmitted signal can be connected to the antenna 210.

The receiving RF unit 220 performs quadrature demodulation to convert (down-convert) the radio signal acquired from the antenna 210 to a base band signal a frequency band for which is lower than that for the radio signal. Then the receiving RF unit 220 outputs the signal after the quadrature demodulation to the A/D converter 225.

The A/D converter 225 converts the continuous signal (analog signal) acquired from the receiving RF unit 220 to discrete signals (digital signals). Then the A/D converter 225 outputs the received signal obtained as the discrete signals to the CP removal unit 230 and the timing detector 240.

The CP removal unit 230 removes a CP length signal from the received signal acquired from the A/D converter 225 on the basis of timing information notice of which the timing detector 240 gives the CP removal unit 230 to extract effective symbol length signals. Then the CP removal unit 230 outputs the signals extracted as effective symbols to the FFT unit 235 in order.

The FFT unit 235 performs a fast Fourier transform on each signal acquired from the CP removal unit 230 as an effective symbol to extract a component associated with each subcarrier. That is to say, the FFT unit 235 converts each time domain signal acquired from the CP removal unit 230 to frequency domain signals. Then the FFT unit 235 outputs the frequency domain signals obtained to the timing detector 240 and the separator 250. A transform algorithm other than a fast Fourier transform may be used for converting each time domain signal to frequency domain signals.

The timing detector 240 determines the timing of an effective symbol included in the received signal on the basis of the time domain received signal acquired from the A/D converter 225 and the frequency domain signals acquired from the FFT unit 235. The timing detector 240 includes a time correlator 241, a frequency correlator 242, and a timing determiner 243.

The time correlator 241 finds a correlation in the time domain between the received signal acquired from the A/D converter 225 and a signal obtained by shifting the received signal in the time direction, and detects timing at which a maximum correlation value is obtained. For example, the time correlator 241 finds the moving average of values which indicate a correlation between the received signal and a signal obtained by delaying the received signal by effective symbol length, and detects timing at which a maximum moving average is obtained. In this case, window width (length of time in which an averaging process is performed) may be guard interval length. Then the time correlator 241 gives the timing determiner 243 notice of the timing detected.

The frequency correlator 242 extracts a signal which is in a position corresponding to a known signal (for example, a preamble signal at the head of a frame) from the frequency domain signals acquired from the FFT unit 235. Then the frequency correlator 242 calculates a difference between actual timing of the effective symbol and current timing of extraction by the CP removal unit 230 by the use of the signal extracted and the original known signal. After that, the frequency correlator 242 informs the timing determiner 243 of the difference (timing correction amount) calculated. A concrete method for calculating a timing correction amount will be described later.

The timing determiner 243 corrects the timing notice of which the time correlator 241 gives the timing determiner 243 on the basis of the timing correction amount notice of which the frequency correlator 242 gives the timing determiner 243, and determines timing at which the effective symbol should be extracted. Then the timing determiner 243 informs the CP removal unit 230 of the timing determined.

The timing detector 240 may perform the above detection process once a frame or periodically at intervals which are shorter or longer than one frame. In addition, the timing detector 240 may properly change the intervals according to, for example, the state of a transmission line.

The separator 250 separates the signals acquired from the FFT unit 235 into time-multiplexed data signals and a pilot signal. Then the separator 250 outputs the pilot signal to the channel estimator 260 and outputs the data signals to the channel compensator 265.

The channel estimator 260 finds a correlation between the pilot signal acquired from the separator 250 and the original pilot signal (replica signal) known to the receiving apparatus 200 and estimates channel distortion on the transmission line. Then the channel estimator 260 informs the channel compensator 265 of a channel estimation value which indicates an estimation result.

The channel compensator 265 performs complex operations on the data signals acquired from the separator 250 according to the channel estimation value of which the channel estimator 260 informs the channel compensator 265 to curb the influence of the channel distortion. Then the channel compensator 265 outputs data signals after the channel compensation to the data demodulator 270.

The data demodulator 270 demodulates the data signals acquired from the channel compensator 265. A demodulation mode corresponds to the modulation mode used by the sending apparatus 100. If the sending apparatus 100 performs adaptive modulation, the data demodulator 270 can recognize a modulation mode currently used by the sending apparatus 100 on the basis of information included in control data transmitted from the sending apparatus 100. Then the data demodulator 270 outputs data (encoded data) after the demodulation to the error-correction decoder 280.

The error-correction decoder 280 performs an error correction process on the encoded data acquired from the data demodulator 270 according to the encoding mode to obtain decoded data. If a bit error cannot be corrected by the error correction process, for example, because the number of bit errors exceeds error correction capability for the encoding mode, then the error-correction decoder 280 can request the sending apparatus 100 to retransmit the data.

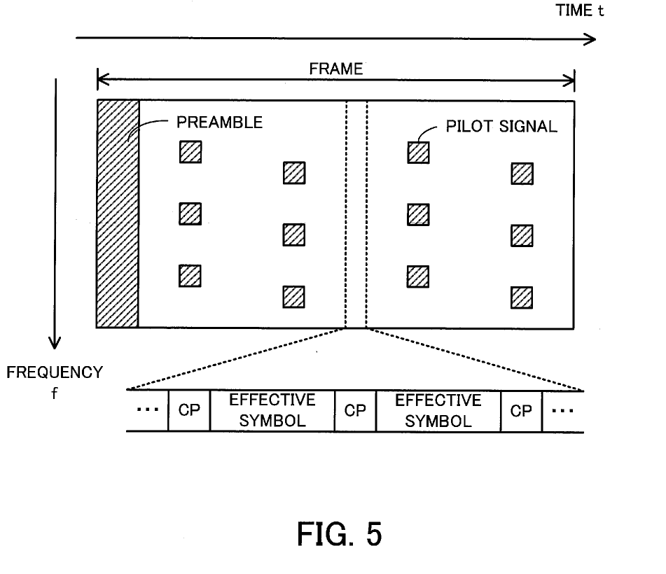

FIG. 5 is a view showing an example of the structure of a frame used in the communication system according to the first embodiment of the present invention. A signal transmitted from the sending apparatus 100 to the receiving apparatus 200 can be identified by separating it into sending units called frames shown in FIG. 5. A frame includes a plurality of effective symbols. A CP which is a replica of at least part of an effective symbol is inserted between the effective symbol and another effective symbol.

In the example of the structure of the frame shown in FIG. 5, a preamble signal which is a known signal is transmitted at the head of the frame by the use of a wide frequency band. The preamble signal may be transmitted by the use of all frequency bands (all subcarriers) that can be used for the sending apparatus 100 and the receiving apparatus 200 or by the use of some frequency bands (subcarriers) between which a proper spacing is set. A pilot signal which is a known signal and which is included in a field other than the preamble is intermittently transmitted by the use of some frequency bands.

The sending apparatus 100 and the receiving apparatus 200 share the above frame structure as knowledge. The frequency correlator 242 of the receiving apparatus 200 can calculate a timing correction amount by the use of the preamble signal or the pilot signal included in a field other than the preamble which is received from the sending apparatus 100. The positions of known signals, such as the preamble signal and the pilot signal included in a field other than the preamble, are not limited to those shown in FIG. 5. That is to say, known signals may occupy other various positions.

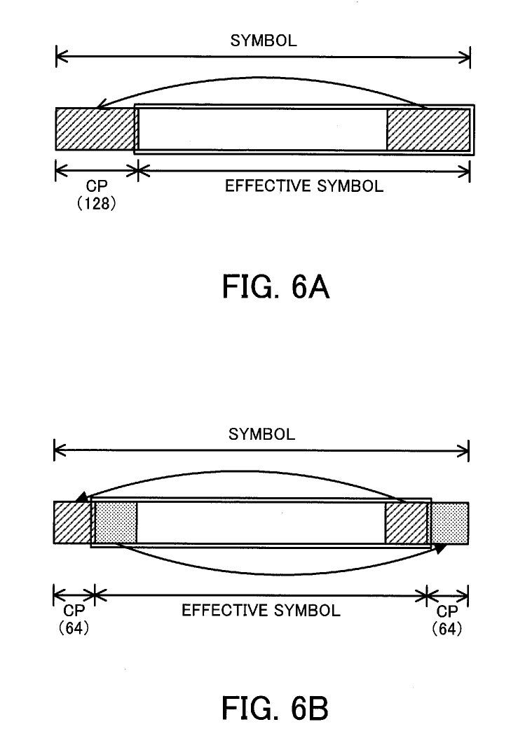

FIGS. 6A and 6B are views showing an example of the structure of a symbol used in the communication system according to the first embodiment of the present invention. In FIGS. 6A and 6B, two methods are shown as an example of a CP (guard interval) insertion method which can be adopted by the CP inserter 145 of the sending apparatus 100.

With a first method shown in FIG. 6A, a replica of a 128-sample signal at the end of an effective symbol is made and the replica is added to the head of the effective symbol as a CP. In this case, a symbol including the 128-sample CP and the subsequent effective symbol is formed. That is to say, the head of the effective symbol appears 128 samples after the head of the symbol.

With a second method shown in FIG. 6B, a replica of a 64-sample signal at the end of an effective symbol is made and the replica is added to the head of the effective symbol as a CP. In addition, a replica of a 64-sample signal at the head of the effective symbol is made and the replica is added to the end of the effective symbol as a CP. In this case, a symbol including the 64-sample CP, the following effective symbol, and the following 64-sample CP is formed. That is to say, the head of the effective symbol appears 64 samples after the head of the symbol.

With the symbol formed by the first method, the 128-sample signal at the head of the symbol and the 128-sample signal at the end of the symbol are equal in contents. With the symbol formed by the second method, the 128-sample signal at the head of the symbol and the 128-sample signal at the end of the symbol are ultimately equal in contents. Therefore, if a correlation in the time domain is detected for the symbol formed by the first method and the symbol formed by the second method, the same position (timing) at which a maximum correlation value is obtained is detected.

A receiving process performed by the receiving apparatus 200 having the above structure will now be described in detail.

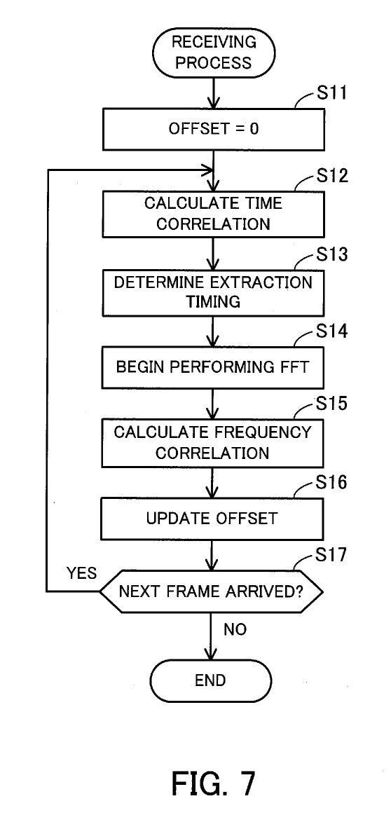

FIG. 7 is a flow chart showing a procedure for a receiving process performed in the receiving apparatus according to the first embodiment of the present invention. A process shown in FIG. 7 will now be described in order of step number. It is assumed that the receiving apparatus 200 updates timing at which an effective symbol is extracted once a frame.

[Step S11] The timing determiner 243 sets a timing offset to zero (0) which is an initial value.

[Step S12] When a new frame arrives, the time correlator 241 detects a correlation in the time domain between a received signal included in the frame (for example, a signal at the head of the frame) and a signal obtained by shifting the received signal in the time direction. For example, the time correlator 241 finds the moving average of values which indicate a correlation between the received signal and a signal obtained by delaying the received signal by effective symbol length at each timing of the received signal.

[Step S13] The time correlator 241 detects timing at which the value found in step S12 is the highest, and informs the timing determiner 243 of the timing detected. The timing determiner 243 determines that timing obtained by shifting the timing of which the time correlator 241 informs the timing determiner 243 by the timing offset (initial value is 0) currently set is extraction timing to be applied to the current frame. Then the timing determiner 243 informs the CP removal unit 230 of the extraction timing determined.

[Step S14] The CP removal unit 230 begins removing a CP from the current frame and extracting an effective symbol from the current frame in accordance with the timing of which the timing determiner 243 informs the CP removal unit 230. The FFT unit 235 acquires effective symbol length signals extracted by the CP removal unit 230. Then the FFT unit 235 performs an FFT in order on the effective symbol length signals to convert them to frequency domain signals.

[Step S15] The frequency correlator 242 extracts a signal corresponding to a known signal (for example, a preamble signal at the head of the frame or a pilot signal included in a field other than the preamble) from the signals obtained by performing an FFT in step S14. Then the frequency correlator 242 calculates a correlation value in the frequency domain by the use of the extracted signal and the original known signal.

[Step S16] The frequency correlator 242 finds the amount of phase rotation caused by an error of the timing at which the effective symbol is extracted on the basis of the correlation value calculated in step S15. Then the frequency correlator 242 finds a time lag (timing correction amount) corresponding to the phase rotation amount. After that, the frequency correlator 242 informs the timing determiner 243 of the timing correction amount found.

The timing determiner 243 updates the timing offset on the basis of the timing correction amount of which the frequency correlator 242 informs the timing determiner 243. That is to say, the timing determiner 243 sets a timing offset obtained by shifting the timing offset (used in step S13) applied to the current frame by the timing correction amount of which the frequency correlator 242 informs the timing determiner 243 as a timing offset to be applied to a next frame. A timing offset after the update is used when the above step S13 is performed next.

[Step S17] The timing detector 240 determines whether the next frame has arrived. If the next frame has arrived, then step S12 is performed and timing detection is performed on the next frame. If the next frame has not arrived, then the receiving process terminates.

As has been described, when a first frame arrives, the receiving apparatus 200 extracts an effective symbol at timing detected by performing correlation detection in the time domain. Then the receiving apparatus 200 feeds back frequency domain signals obtained by converting a time domain signal extracted and finds the difference (correction amount) between actual extraction timing and ideal extraction timing. When a next frame arrives later, the receiving apparatus 200 corrects the timing detected by performing correlation detection in the time domain by the use of the correction amount previously found, and extracts an effective symbol.

An opportunity to update timing at which an effective symbol is extracted is not limited to that shown in the above flow chart. Other various opportunities can be used. For example, the timing offset after the update may be applied not to the next frame but to the frame which is currently being processed. In addition, correlation detection in the time domain or the update of a timing offset may be performed not once a frame but plural times a frame or once plural frames.

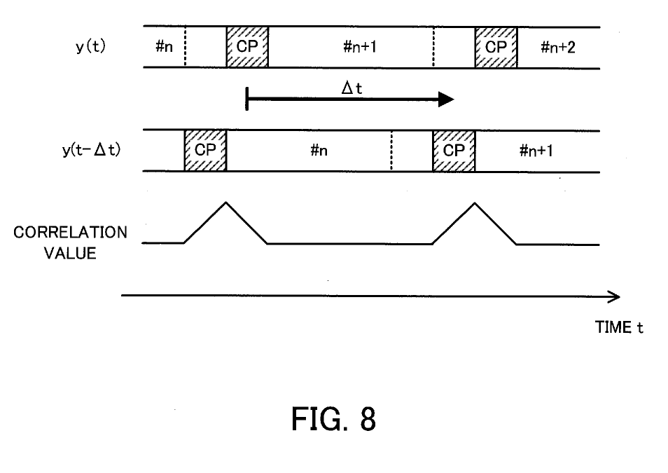

FIG. 8 is a view showing a method for calculating a time correlation in the receiving apparatus according to the first embodiment of the present invention. The time correlator 241 of the receiving apparatus 200 can detect timing in the time domain by a method shown in FIG. 8. In this example, the time correlator 241 holds a received signal y(t) and a delayed signal y(t−Δt) obtained by delaying the received signal by effective symbol length Δt. Then the time correlator 241 finds a value at each time t which indicates a correlation between the received signal y(t) and the delayed signal y(t−Δt).

To be concrete, the time correlator 241 finds the product of the received signal y(t) and a conjugate complex number of the delayed signal y(t−Δt) at each time t and defines their moving average as a correlation value. The length of time in which an averaging process is performed is guard interval length. That is to say, a moving average at time t is the average of values obtained in an interval from the time t to the guard interval length before the time t.

If a CP is inserted by the method shown in FIG. 6A, each peak of correlation values is detected at the head of an effective symbol included in the delayed signal y(t−Δt). In this example, a high correlation value is obtained at a position where the timing of last 128 samples of an effective symbol #n and a CP added to the effective symbol #n match. A peak of the correlation values (moving averages) is detected at the head of the effective symbol #n included in the delayed signal y(t−Δt). Similarly, a peak of the correlation values (moving averages) is detected at the head of an effective symbol #(n+1) included in the delayed signal y(t−Δt).

The principles underlying the calculation of a timing correction amount by the use of a frequency domain signal after a Fourier transform will now be described. If an effective symbol can be extracted accurately, a frequency domain signal y(f) obtained by performing a Fourier transform on an extracted signal can be defined by equation (1). In equation (1), h(f) is a channel response value and indicates an influence, such as fading, which a transmission line has on a transmitted signal. s(f) is the transmitted signal and n(f) is a noise component.

[Equation 1]

y(f)=h(f)s(f)+n(f) (1)

A correlation value Q defined by equation (2) will now be described. In equation (2), Δf is predetermined frequency width and an asterisk (“*”) means a complex conjugate. That is to say, the correlation value Q indicates a correlation in the frequency domain between a first signal obtained by dividing a received signal by a transmitted signal corresponding thereto and a second signal obtained by shifting the first signal by a predetermined frequency. It is assumed that communication quality is perfectly good. Then a value obtained by dividing the noise component n(f) by the transmitted signal s(f) can be considered to be approximately equal to 0. In addition, it is assumed that a flat fading environment exists. Then h(f) can be considered to be approximately equal to h(f+Δf). Therefore, if the above assumptions are made, the correlation value Q is considered to be approximately equal to a value which depends on the channel response value h(f) and which does not contain an imaginary component.

$$\begin{matrix}[ Equation 2 ] & \\ \begin{matrix}Q = {\sum }_{f}^{ } ( \frac{y ( f )}{s ( f )} ) {( \frac{y ( f + Δ f )}{s ( f + Δ f )} )}^{*} \\ \approx {\sum }_{f}^{ } h ( f ) {h}^{*} ( f + Δ f ) \\ \approx {\sum }_{f}^{ } {\vert h ( f ) \vert}^{2}\end{matrix} & ( 2 )\end{matrix}$$

On the other hand, it is assumed that an effective symbol cannot be extracted accurately. It is assumed that a signal is extracted at a position which shifts from the correct position of an effective symbol by time τ. Then phase rotation corresponding to the time τ occurs in a frequency domain signal. To be concrete, a frequency domain signal obtained by performing a Fourier transform on the signal extracted at the position which shifts from the correct position of the effective symbol by the time τ can be defined by equation (3).

[Equation 3]

e^{-j2πfτ}y(f)=e^{-j2πfτ}h(f)s(f)+e^{-j2πfτ}n(f) (3)

A correlation value R defined by equation (4) will now be discussed on the basis of thinking which is the same as that about the correlation value Q. That is to say, the correlation value R indicates a correlation in the frequency domain between a first signal obtained by dividing a received signal by a transmitted signal corresponding thereto and a second signal obtained by shifting the first signal by a predetermined frequency. It is assumed that communication quality is perfectly good and that a flat fading environment exists. Then the correlation value R is considered to be approximately equal to the product of a value which depends on the channel response value h(f) and which does not contain an imaginary component and a value which depends on the frequency width Δf and the time τ and which contains an imaginary component.

$$\begin{matrix}[ Equation 4 ] & \\ \begin{matrix}R = {\sum }_{f}^{ } ( \frac{{e}^{- j 2 π f τ} y ( f )}{s ( f )} ) {( \frac{{e}^{- j 2 π ( f + Δ f ) τ} y ( f + Δ f )}{s ( f + Δ f )} )}^{*} \\ \approx {e}^{- j 2 π Δ f τ} {\sum }_{f}^{ } h ( f ) {h}^{*} ( f + Δ f ) \\ \approx {e}^{- j 2 π Δ f τ} {\sum }_{f}^{ } {\vert h ( f ) \vert}^{2}\end{matrix} & ( 4 )\end{matrix}$$

That is to say, if a correlation value calculated by the above method contains an imaginary component, then the determination that an effective symbol is not extracted at a correct position can be made. Δf is a known value, so the time τ can be found from the correlation value R by the use of equation (5). In equation (5), arg(R) means an angular component of the correlation value R on a complex plane.

$$\begin{matrix}[ Equation 5 ] & \\ τ = \frac{arg ( R )}{2 π Δ f} & ( 5 )\end{matrix}$$

The receiving apparatus 200 can calculate the time τ as a timing correction amount according to the principles which have been described. In this case, the receiving apparatus 200 may use a known signal as the transmitted signal s(f). Furthermore, an arbitrary value can be set as the frequency width Δf. However, h(f) is considered to be approximately equal to h(f+Δf), so it is desirable that the frequency width Δf should be a small value. For example, a spacing between subcarriers is set as the frequency width Δf.

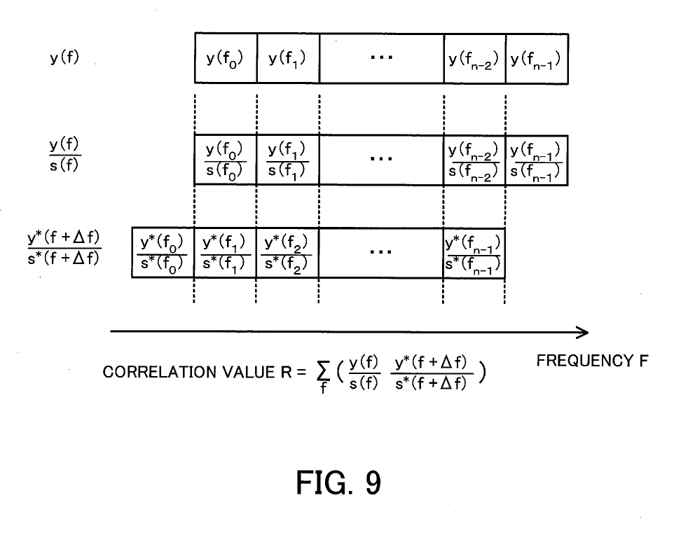

FIG. 9 is a view showing a method for calculating a frequency correlation in the receiving apparatus according to the first embodiment of the present invention. The frequency correlator 242 of the receiving apparatus 200 can calculate a timing correction amount in the frequency domain by a method shown in FIG. 9. The example shown in FIG. 9 follows the calculation principles indicated by the above equations (1) through (5).

First the frequency correlator 242 acquires a received signal y(f) in the frequency domain corresponding to a known signal. Then the frequency correlator 242 finds a first signal obtained by dividing the received signal y(f) by the original known signal s(f) for each subcarrier. In addition, the frequency correlator 242 finds a second signal which is a conjugate complex number of a signal obtained by shifting the first signal by the frequency width Δf. The frequency correlator 242 finds the product of the first signal and the second signal and totals values obtained for all of the subcarriers. By doing so, the frequency correlator 242 finds a correlation value R. After that, the frequency correlator 242 can find a timing correction amount from an angular component of the correlation value R.

In FIG. 9, the frequency width Δf is set to the frequency width of one subcarrier. However, the frequency width Δf may be set to the frequency width of plural subcarriers. In addition, the first signal may be shifted in the reverse direction. Furthermore, a conjugate complex number may be used not as the second signal but as the first signal.

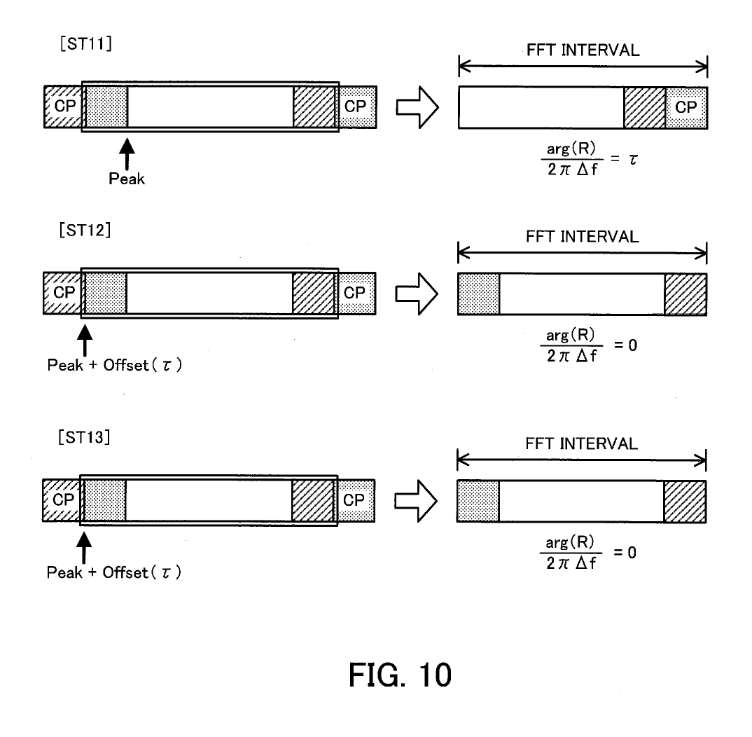

FIG. 10 is a view showing an example of the result of effective symbol extraction performed in the receiving apparatus according to the first embodiment of the present invention. In this example, it is assumed that the insertion method shown in FIG. 6A is the prevailing CP insertion method used by many sending apparatus. On the side of the receiving apparatus 200 it is assumed that the prevailing CP insertion method is used. In addition, it is assumed that the receiving apparatus 200 performs correlation detection in the time domain by the method shown in FIG. 8. On the other hand, it is assumed that the sending apparatus 100 uses the irregular CP insertion method shown in FIG. 6B.

When the receiving apparatus 200 acquires a first frame from the sending apparatus 100, the receiving apparatus 200 detects timing in the time domain at which a maximum correlation value is obtained, and makes an attempt to extract an effective symbol at the timing detected. However, the irregular CP insertion method is used, so the timing detected differs from actual timing of the effective symbol. For example, the receiving apparatus 200 erroneously determines that the head of the effective symbol appears 64 samples after the actual head of the effective symbol. Accordingly, phase rotation occurs in signals obtained by performing a Fourier transform on the first frame. As a result, it is difficult to correctly perform demodulation and decoding.

On the other hand, the receiving apparatus 200 detects by the use of the signals obtained by performing a Fourier transform on the first frame that extraction timing is shifted by time τ. Then the receiving apparatus 200 sets a timing offset to be applied to a second frame to τ (step ST11).

When the receiving apparatus 200 acquires the second frame from the sending apparatus 100, the receiving apparatus 200 detects timing in the time domain at which a maximum correlation value is obtained. Then the receiving apparatus 200 corrects the timing detected by the timing offset τ and makes an attempt to extract an effective symbol. It is assumed that timing after the correction matches actual timing of the effective symbol. Then the receiving apparatus 200 detects by the use of signals obtained by performing a Fourier transform that current extraction timing is not shifted. As a result, the current timing offset τ is maintained (step ST12).

When the receiving apparatus 200 acquires a third frame from the sending apparatus 100, the receiving apparatus 200 detects timing in the time domain at which a maximum correlation value is obtained. Then the receiving apparatus 200 corrects the timing detected by the timing offset τ and extracts an effective symbol. After that, the receiving apparatus 200 can extract an effective symbol at correct timing (step ST13).

If a correction amount obtained according to the calculation principles indicated by the above equations (1) through (5) is a positive value, then timing is shifted in an early direction (to the left in FIG. 10). On the other hand, if a correction amount is a negative value, then timing is shifted in a late direction (to the right in FIG. 10). In the example shown in FIG. 10, the timing offset τ is a positive value.

In the foregoing the descriptions have been given on the assumption that a CP has been inserted into a received signal by an irregular method. However, timing correction by the use of a frequency domain signal is also useful for a received signal on which a time filtering process has been performed. If the sending apparatus 100 has performed a time filtering process on all symbols, a high peak of correlation values may not be obtained by detecting a correlation in the time domain. As a result, the determination that a maximum correlation value is obtained at a position which shifts from an original position at which an effective symbol starts may be made. Even in such a case, timing correction can be performed properly by calculating a timing offset by the use of a frequency domain signal.

By using the above communication system, the position of an effective symbol can be determined properly even in cases where a sending apparatus which is not based on the communication standards is used. That is to say, the receiving apparatus 200 corrects timing obtained by detecting a correlation in the time domain on the basis of a feedback signal after a Fourier transform. By doing so, the receiving apparatus 200 can flexibly process a signal transmitted from a sending apparatus which uses an irregular CP (guard interval) insertion method or which performs a time filtering process on a symbol. This avoids situations under which the receiving apparatus 200 cannot communicate at all with some sending apparatus or situations under which a transmission rate significantly drops, and contributes to the improvement of the quality of a communication system.

In the first embodiment of the present invention an OFDM communication system is taken as an example. However, the above communication system can be applied to other communication modes in which a received signal contains a guard interval. For example, a communication mode in which the OFDM mode and a code division multiple access (CDMA) mode are combined may be used. In addition, the block structure shown in FIG. 3 or 4 can be changed according to a communication mode selected.

### Second Embodiment

In a multipath environment, a preceding wave and a delayed wave overlap in a signal which a receiving apparatus acquires. In this case, timing at which a maximum correlation value is obtained at the time of detecting a correlation in the time domain shifts backward (to late timing) from a position at which an effective symbol included in the preceding wave starts by the influence of the delayed wave. Accordingly, if a receiving apparatus extracts an effective symbol length signal on the basis of the timing detected, then a symbol signal which appears right after the effective symbol in the preceding wave is included at the end of an extraction interval.

Extracting the signal including another symbol signal as the effective symbol causes a deterioration in the accuracy of a demodulation and decoding process performed later. Therefore, the method of determining with the influence of the delayed wave taken into consideration in advance that a position (early timing) predetermined length before timing at which a maximum correlation value is obtained is the position of the effective symbol may be adopted. With this method, however, a signal extraction position is shifted forward in the time domain, so phase rotation occurs in frequency domain signals after conversion. As a result, an operation for restoring the phase rotation caused by the signal extraction is performed on the frequency domain signals obtained.

A second embodiment of the present invention will now be described in detail with reference to the drawings.

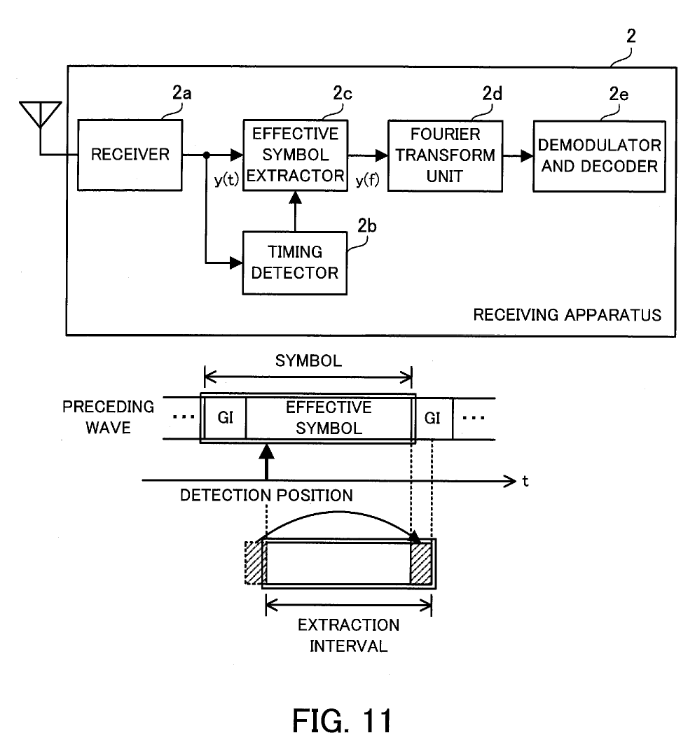

FIG. 11 is a view for giving an overview of a receiving apparatus according to a second embodiment of the present invention. A receiving apparatus 2 comprises a receiver 2a, a timing detector 2b, an effective symbol extractor 2c, a Fourier transform unit 2d, and a demodulator and decoder 2e.

The receiver 2a acquires a signal from a sending apparatus which transmits a signal including effective symbols and guard intervals. An effective symbol is a unit of predetermined signal processing, such as modulation and demodulation. A guard interval is inserted between effective symbols by the sending apparatus and is a replica of at least part of an effective symbol.

The timing detector 2b determines a position of an effective symbol on the basis of the received signal acquired by the receiver 2a and informs the effective symbol extractor 2c of the position. To be concrete, the timing detector 2b finds a correlation in the time domain between the received signal and a signal obtained by shifting the received signal in the time direction (for example, a signal obtained by delaying the received signal by effective symbol length) and detects timing at which a maximum correlation value is obtained.

The effective symbol extractor 2c specifies an extraction interval in which an effective symbol is extracted from the received signal acquired by the receiver 2a on the basis of the notice sent from the timing detector 2b. Then the effective symbol extractor 2c extracts a predetermined length signal which appears before the extraction interval (for example, a 16-sample signal which appears just before the extraction interval) from the received signal. The effective symbol extractor 2c replaces a predetermined length signal (16-sample signal, for example) at the end of the extraction interval with the signal extracted from before the extraction interval.

The Fourier transform unit 2d converts a signal (time domain signal) included in the extraction interval after the replacement by the effective symbol extractor 2c to frequency domain signals by the use of, for example, an FFT. However, a conversion algorithm other than an FFT may be used.

The demodulator and decoder 2e acquires the frequency domain signals from the Fourier transform unit 2d and performs a demodulation and decoding process. For example, the demodulator and decoder 2e performs channel estimation, channel compensation, a demodulation process, and an error correction decoding process. As a result, data transmitted by the sending apparatus is restored.

With the receiving apparatus 2 having the above structure, the receiver 2a acquires a signal in which a guard interval that is a replica of at least part of an effective symbol is inserted between the effective symbol and another effective symbol. The timing detector 2b detects timing at which there is a maximum correlation between the received signal and a signal obtained by shifting the received signal in the time direction. Then the effective symbol extractor 2c finds an extraction interval in which an effective symbol length signal is extracted from the received signal, and replaces a predetermined length signal at the end of the extraction interval with a predetermined length signal which appears before the extraction interval.

As a result, the receiving apparatus 2 can easily curb the influence of a delayed wave at the time of extracting an effective symbol. That is to say, the timing detector 2b may detect timing which is later than the timing of an effective symbol included in a preceding wave by the influence of the delayed wave. A symbol signal which appears one after a target symbol signal is included in an end portion of the extraction interval. However, the effective symbol extractor 2c replaces the symbol signal included in the end portion of the extraction interval with the same target symbol signal, so a symbol signal other than the target symbol signal is not included in the extraction interval in which a Fourier transform is to be performed. This prevents a deterioration in the accuracy of a demodulation and decoding process caused by the influence of the delayed wave.

Unlike a method in which an extraction interval is shifted forward in the time domain, phase rotation does not occur in signals obtained by performing a Fourier transform. As a result, the number of times an operation must be performed on frequency domain signals can be reduced. Accordingly, the influence of the delayed wave can be curbed more easily and various effects, such as a reduction in the processing load on the receiving apparatus 2, the power consumption of the receiving apparatus 2, and the circuit scale of the receiving apparatus 2, can be obtained.

A communication system according to a second embodiment of the present invention will now be described in detail. A communication system according to a second embodiment of the present invention can be realized by adopting the structure of the communication system according to the first embodiment of the present invention shown in FIG. 2. In addition, a sending apparatus according to a second embodiment of the present invention can be realized by adopting the block structure of the sending apparatus 100 according to the first embodiment of the present invention shown in FIG. 3. The structure of a receiving apparatus 300 used in the second embodiment of the present invention and a receiving process will now be described in detail.

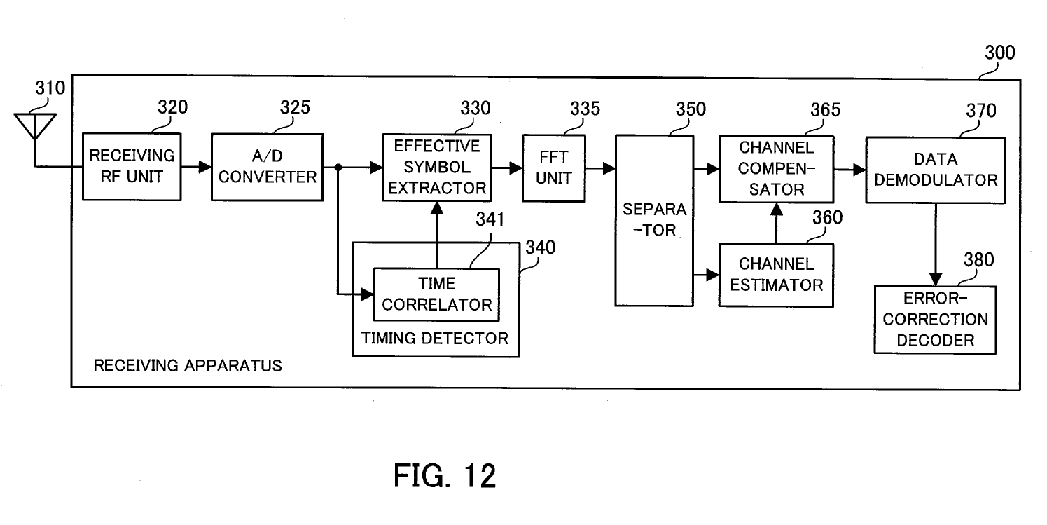

FIG. 12 is a block diagram showing a receiving apparatus according to the second embodiment of the present invention. The receiving apparatus 300 includes an antenna 310, a receiving RF unit 320, an A/D converter 325, an effective symbol extractor 330, an FFT unit 335, a timing detector 340, a separator 350, a channel estimator 360, a channel compensator 365, a data demodulator 370, and an error-correction decoder 380.

The receiving RF unit 320 and the A/D converter 325 correspond to the receiver 2a shown in FIG. 11. The effective symbol extractor 330 corresponds to the effective symbol extractor 2c shown in FIG. 11. The FFT unit 335 corresponds to the Fourier transform unit 2d shown in FIG. 11. The timing detector 340 corresponds to the timing detector 2b shown in FIG. 11. The separator 350, the channel estimator 360, the channel compensator 365, the data demodulator 370, and the error-correction decoder 380 correspond to the demodulator and decoder 2e shown in FIG. 11.

The functions of the antenna 310, the receiving RF unit 320, the A/D converter 325, the FFT unit 335, the separator 350, the channel estimator 360, the channel compensator 365, the data demodulator 370, and the error-correction decoder 380 are the same as those of the antenna 210, the receiving RF unit 220, the A/D converter 225, the FFT unit 235, the separator 250, the channel estimator 260, the channel compensator 265, the data demodulator 270, and the error-correction decoder 280, respectively, included in the receiving apparatus 200 according to the first embodiment of the present invention shown in FIG. 4.

The effective symbol extractor 330 removes a CP length signal from a received signal acquired from the A/D converter 325 on the basis of timing information notice of which the timing detector 340 gives the effective symbol extractor 330 to extract an effective symbol length signal. At this time the effective symbol extractor 330 replaces a predetermined length signal (16-sample signal, for example) at the end of an extraction interval with another signal included in a same symbol. For example, a 16-sample signal which appears just before the extraction interval may be used for the replacement. Then the effective symbol extractor 330 outputs extracted signals after the replacement in order to the FFT unit 335.

The timing detector 340 determines the timing of the effective symbol included in the received signal on the basis of the received signal in the time domain acquired from the A/D converter 325. The timing detector 340 includes a time correlator 341. The time correlator 341 finds a correlation in the time domain between the received signal acquired from the A/D converter 325 and a signal obtained by shifting the received signal in the time direction, and detects timing at which a maximum correlation value is obtained. Then the time correlator 341 informs the effective symbol extractor 330 of the timing obtained by performing the correlation detection.

For example, the time correlator 341 can use the method which is used in the first embodiment of the present invention and which is shown in FIG. 8. That is to say, the time correlator 341 finds the moving average of values which indicate a correlation between the received signal and a signal obtained by delaying the received signal by effective symbol length, and detects timing at which a maximum moving average is obtained. In this case, window width (length of time in which an averaging process is performed) may be guard interval length.

The timing detector 340 may perform the above detection process once a frame or periodically at intervals which are shorter or longer than one frame. In addition, the timing detector 340 may properly change the intervals according to, for example, the state of a transmission line.

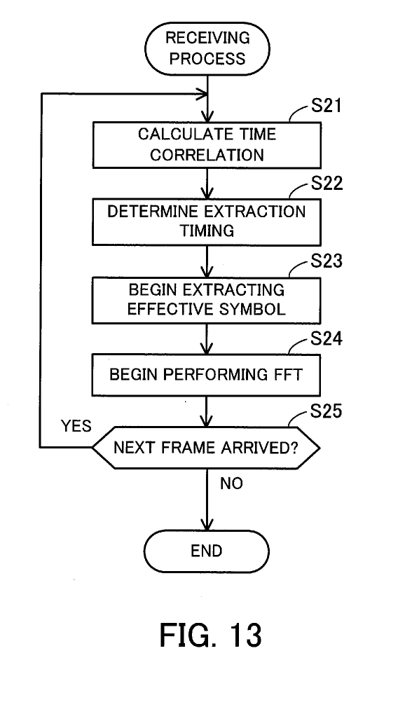

FIG. 13 is a flow chart showing a procedure for a receiving process performed in the receiving apparatus according to the second embodiment of the present invention. A process shown in FIG. 13 will now be described in order of step number. It is assumed that the receiving apparatus 300 updates timing at which an effective symbol is extracted once a frame.

[Step S21] When a new frame arrives, the time correlator 341 detects a correlation in the time domain between a received signal included in the frame (for example, a signal at the head of the frame) and a signal obtained by shifting the received signal in the time direction. For example, the time correlator 341 finds the moving average of values which indicate a correlation between the received signal and a signal obtained by delaying the received signal by the effective symbol length at each timing of the received signal.

[Step S22] The time correlator 341 detects timing at which the value found in step S21 is the highest, and informs the effective symbol extractor 330 of the timing detected.

[Step S23] The effective symbol extractor 330 begins removing a CP from the current frame and extracting an effective symbol from the current frame in accordance with the timing of which the time correlator 341 informs the effective symbol extractor 330. At this time the effective symbol extractor 330 replaces a predetermined length (16-sample, for example) signal at the end of an extraction interval with a predetermined length (16-sample, for example) signal which appears just before the extraction interval.

[Step S24] The FFT unit 335 acquires effective symbol length signals after the replacement process by the effective symbol extractor 330 and performs an FFT on the effective symbol length signals in order. By doing so, the effective symbol length signals are converted to frequency domain signals.

[Step S25] The timing detector 340 determines whether a next frame has arrived. If the next frame has arrived, then step S21 is performed and timing detection is performed on the next frame. If the next frame has not arrived, then the receiving process terminates.

As has been described, when a frame transmitted from a sending apparatus 100 arrives, the receiving apparatus 300 extracts an effective symbol at timing detected by performing correlation detection in the time domain. At this time the receiving apparatus 300 replaces a signal at the end of the extraction interval with a signal which appears before the extraction interval. Then the receiving apparatus 300 performs a Fourier transform on an extracted signal after the replacement process.

An opportunity to update timing at which an effective symbol is extracted is not limited to that shown in the above flow chart. Other various opportunities can be used. For example, correlation detection in the time domain may be performed not once a frame but plural times a frame or once plural frames.

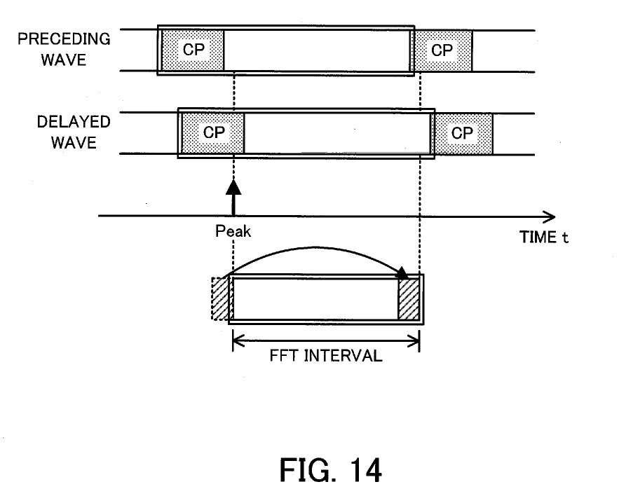

FIG. 14 is a view showing an example of the result of effective symbol extraction performed in the receiving apparatus according to the second embodiment of the present invention. In a multipath environment the receiving apparatus 300 receives a signal in which a preceding wave and a delayed wave that arrives after the preceding wave overlap.

If the receiving apparatus 300 performs correlation detection by the method shown in FIG. 8, a maximum correlation value may be obtained between the head of an effective symbol included in the preceding wave and the head of the effective symbol included in the delayed wave by the influence of the delayed wave. If an extraction interval (FFT interval) with effective symbol length is set with timing at which the maximum correlation value is obtained as its head, then a CP of another symbol included in the preceding wave appears at the end of the FFT interval.

In this state, the receiving apparatus 300 discards a 16-sample signal at the end of the FFT interval and replaces the 16-sample signal discarded with a 16-sample signal which appears just before the FFT interval. As a result, an effective symbol length signal which does not include another symbol signal is obtained.

By using the above communication system, the influence of a delayed wave can be curbed easily at the time of extracting an effective symbol. That is to say, the receiving apparatus 300 sets an extraction interval (FFT interval) on the basis of timing detected by performing correlation detection in the time domain, and replaces a signal at the end of the extraction interval with a signal which appears before the extraction interval. This eliminates another symbol signal from the extraction interval and prevents a deterioration in the accuracy of a demodulation and decoding process. In addition, the extraction interval is not shifted in the time domain, so phase rotation does not occur in frequency domain signals. Accordingly, there is no need to perform operations for restoring phase rotation. This contributes to a reduction in the processing load on the receiving apparatus 300, the power consumption of the receiving apparatus 300, and the circuit scale of the receiving apparatus 300.

In the second embodiment of the present invention an OFDM communication system is taken as an example. However, the above communication system can be applied to other communication modes in which a received signal contains a guard interval. In addition, the block structure shown in FIG. 12 can be changed according to a communication mode selected.

### Third Embodiment

A third embodiment of the present invention will now be described in detail with reference to the drawings. A communication system according to a third embodiment of the present invention combines the timing correction function of the communication system according to the first embodiment of the present invention and the delayed wave processing function of the communication system according to the second embodiment of the present invention.

The communication system according to the third embodiment of the present invention can be realized by adopting the structure of the communication system according to the first embodiment of the present invention shown in FIG. 2. In addition, a sending apparatus according to the third embodiment of the present invention can be realized by adopting the block structure of the sending apparatus 100 according to the first embodiment of the present invention shown in FIG. 3. The structure of a receiving apparatus 400 used in the third embodiment of the present invention and a receiving process will now be described in detail.

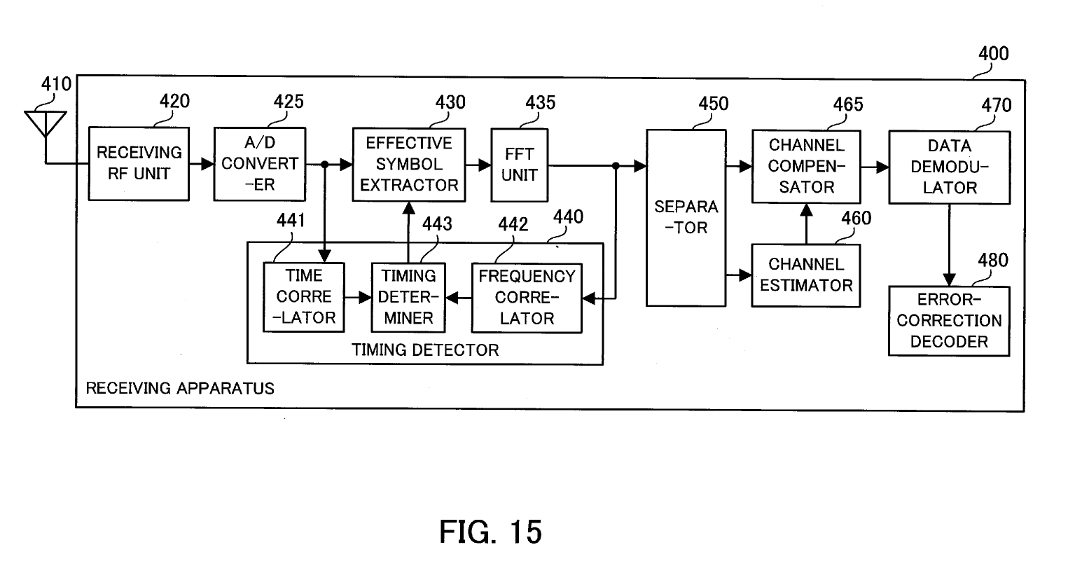

FIG. 15 is a block diagram showing a receiving apparatus according to a third embodiment of the present invention. The receiving apparatus 400 includes an antenna 410, a receiving RF unit 420, an A/D converter 425, an effective symbol extractor 430, an FFT unit 435, a timing detector 440, a separator 450, a channel estimator 460, a channel compensator 465, a data demodulator 470, and an error-correction decoder 480.

The functions of the antenna 410, the receiving RF unit 420, the A/D converter 425, the FFT unit 435, the separator 450, the channel estimator 460, the channel compensator 465, the data demodulator 470, and the error-correction decoder 480 are the same as those of the antenna 210, the receiving RF unit 220, the A/D converter 225, the FFT unit 235, the separator 250, the channel estimator 260, the channel compensator 265, the data demodulator 270, and the error-correction decoder 280, respectively, included in the receiving apparatus 200 according to the first embodiment of the present invention shown in FIG. 4.

The effective symbol extractor 430 removes a CP length signal from a received signal acquired from the A/D converter 425 on the basis of timing information of which a timing determiner 443 informs the effective symbol extractor 430 to extract an effective symbol length signal. At this time the effective symbol extractor 430 replaces a predetermined length signal at the end of an extraction interval with another signal included in a same symbol. For example, a predetermined length signal which appears just before the extraction interval may be used for the replacement. Then the effective symbol extractor 430 outputs extracted signals after the replacement in order to the FFT unit 435.

The timing detector 440 determines the timing of an effective symbol included in the received signal on the basis of the time domain received signal acquired from the A/D converter 425 and frequency domain signals acquired from the FFT unit 435. The timing detector 440 includes a time correlator 441, a frequency correlator 442, and a timing determiner 443.

The time correlator 441 finds a correlation in the time domain between the received signal acquired from the A/D converter 425 and a signal obtained by shifting the received signal in the time direction, and detects timing at which a maximum correlation value is obtained. Then the time correlator 441 informs the timing determiner 443 of the timing detected. In this case, the time correlator 441 can use the detection method which is used in the first embodiment of the present invention and which is shown in FIG. 8.

The frequency correlator 442 extracts a signal which occupies a position corresponding to a known signal from the frequency domain signals acquired from the FFT unit 435. Then the frequency correlator 442 calculates a difference between actual timing of the effective symbol and current timing of extraction by the effective symbol extractor 430 by the use of the signal extracted and the original known signal. After that, the frequency correlator 442 informs the timing determiner 443 of the difference (timing correction amount) calculated. In this case, the frequency correlator 442 can use the calculation method which is used in the first embodiment of the present invention and which is shown in FIG. 9.

The timing determiner 443 corrects the timing notice of which the time correlator 441 gives the timing determiner 443 on the basis of the timing correction amount notice of which the frequency correlator 442 gives the timing determiner 443, and determines timing at which the effective symbol should be extracted. Then the timing determiner 443 informs the effective symbol extractor 430 of the timing determined.

The timing detector 440 may perform the above detection process once a frame or periodically at intervals which are shorter or longer than one frame. In addition, the timing detector 440 may properly change the intervals according to, for example, the state of a transmission line.

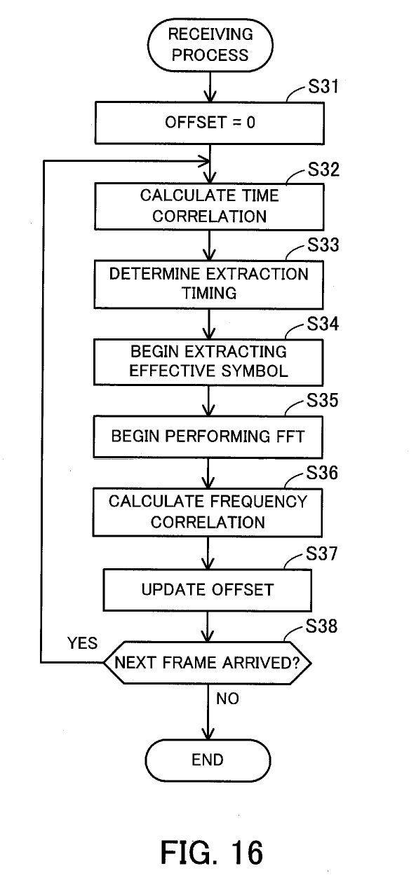

FIG. 16 is a flow chart showing a procedure for a receiving process performed in the receiving apparatus according to the third embodiment of the present invention. A process shown in FIG. 16 will now be described in order of step number. It is assumed that the receiving apparatus 400 updates timing at which an effective symbol is extracted once a frame.

[Step S31] The timing determiner 443 sets a timing offset to zero (0) which is an initial value.

[Step S32] When a new frame arrives, the time correlator 441 detects a correlation in the time domain between a received signal included in the frame and a signal obtained by shifting the received signal in the time direction.

[Step S33] The time correlator 441 detects timing at which the value found in step S32 is the highest, and informs the timing determiner 443 of the timing detected. The timing determiner 443 determines that timing obtained by shifting the timing of which the time correlator 441 informs the timing determiner 443 by the timing offset currently set is extraction timing to be applied to the current frame. Then the timing determiner 443 informs the effective symbol extractor 430 of the extraction timing determined.

[Step S34] The effective symbol extractor 430 begins removing a CP from the current frame and extracting an effective symbol from the current frame in accordance with the timing of which the timing determiner 443 informs the effective symbol extractor 430. At this time the effective symbol extractor 430 replaces a predetermined length signal at the end of an extraction interval with a predetermined length signal which appears just before the extraction interval.

[Step S35] The FFT unit 435 acquires signals after the replacement process by the effective symbol extractor 430 and performs an FFT in order on the signals. By doing so, the signals are converted to frequency domain signals.

[Step S36] The frequency correlator 442 extracts a signal corresponding to a known signal from the signals obtained by performing an FFT in step S35. Then the frequency correlator 442 calculates a correlation value in the frequency domain by the use of the extracted signal and the original known signal.

[Step S37] The frequency correlator 442 finds the amount of phase rotation caused by an error of the timing at which the effective symbol is extracted on the basis of the correlation value calculated in step S36. Then the frequency correlator 442 finds a time lag (timing correction amount) corresponding to the phase rotation amount. After that, the frequency correlator 442 informs the timing determiner 443 of the timing correction amount found. The timing determiner 443 updates the timing offset on the basis of the timing correction amount of which the frequency correlator 442 informs the timing determiner 443.

[Step S38] The timing detector 440 determines whether a next frame has arrived. If the next frame has arrived, then step S32 is performed and timing detection is performed on the next frame. If a next frame has not arrived, then the receiving process terminates.

As has been described, when a first frame arrives, the receiving apparatus 400 extracts an effective symbol at timing detected by performing correlation detection in the time domain. At this time the receiving apparatus 400 replaces a signal at the end of an extraction interval with a signal which appears before the extraction interval. Then the receiving apparatus 400 feeds back frequency domain signals obtained by converting a time domain signal extracted and finds the difference (correction amount) between actual extraction timing and ideal extraction timing. When a next frame arrives later, the receiving apparatus 400 corrects the timing detected by performing correlation detection in the time domain by the use of the correction amount previously found, and extracts an effective symbol.

An opportunity to update timing at which an effective symbol is extracted is not limited to that shown in the above flow chart. Other various opportunities can be used. For example, the timing offset after the update may immediately be applied not to the next frame but to the frame which is currently being processed. In addition, correlation detection in the time domain or the update of a timing offset may be performed not once a frame but plural times a frame or once plural frames.

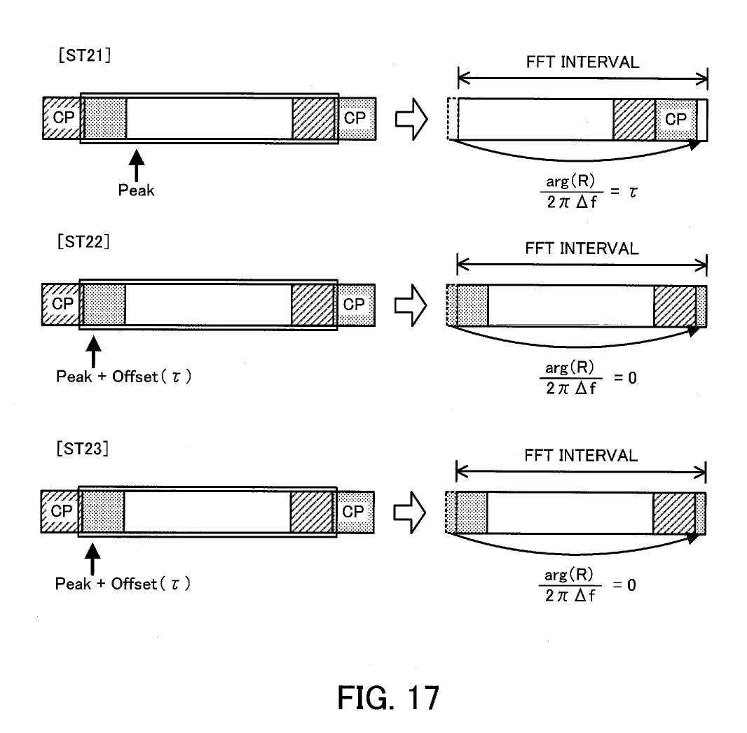

FIG. 17 is a view showing an example of the result of effective symbol extraction performed in the receiving apparatus according to the third embodiment of the present invention. It is assumed that a sending apparatus 100 uses the irregular CP insertion method shown in FIG. 6B.

When the receiving apparatus 400 acquires a first frame from the sending apparatus 100, the receiving apparatus 400 detects timing in the time domain at which a maximum correlation value is obtained, and makes an attempt to extract an effective symbol at the timing detected. The timing detected lags behind an actual head of the effective symbol by 64 samples and lags further by an amount corresponding to the influence of a delayed wave. The receiving apparatus 400 sets an effective symbol length extraction interval (FFT interval) with the timing detected as its head.

In this state, the receiving apparatus 400 discards a 16-sample signal at the end of the FFT interval and replaces the 16-sample signal discarded with a 16-sample signal which appears just before the FFT interval. After that, the receiving apparatus 400 detects by the use of signals obtained by performing a Fourier transform on the first frame that extraction timing is shifted by time τ. The receiving apparatus 400 sets a timing offset to be applied to a second frame to τ (step ST21).

When the receiving apparatus 400 acquires the second frame from the sending apparatus 100, the receiving apparatus 400 detects timing in the time domain at which a maximum correlation value is obtained. Then the receiving apparatus 400 corrects the timing detected by the timing offset τ and makes an attempt to extract an effective symbol. Timing after the correction lags behind the actual head of the effective symbol by the amount corresponding to the influence of the delayed wave. The receiving apparatus 400 performs a replacement process at the end of the FFT interval. This is the same with the first frame. In addition, the receiving apparatus 400 detects by the use of signals obtained by performing a Fourier transform that current extraction timing is not shifted. As a result, the current timing offset τ is maintained (step ST22).

When the receiving apparatus 400 acquires a third frame from the sending apparatus 100, the receiving apparatus 400 detects timing in the time domain at which a maximum correlation value is obtained. Then the receiving apparatus 400 corrects the timing detected by the timing offset τ and extracts an effective symbol. Timing after the correction lags behind the actual head of the effective symbol by the amount corresponding to the influence of the delayed wave. After that, the receiving apparatus 400 can extract a proper signal and perform a Fourier transform (step ST23).

By using the above communication system, the same effects that can be obtained by the communication systems according to the first and second embodiments of the present invention can be achieved. That is to say, the position of an effective symbol can be determined properly even in cases where a sending apparatus which is not based on the communication standards is used. In addition, when an effective symbol is extracted, the influence of a delayed wave can be curbed easily.

In the third embodiment of the present invention an OFDM communication system is taken as an example. However, the above communication system can be applied to other communication modes in which a received signal contains a guard interval. In addition, the block structure shown in FIG. 15 can be changed according to a communication mode selected.

According to the above receiving apparatus and receiving methods, the position of an effective symbol can be determined properly. Furthermore, according to the above receiving apparatus and receiving methods, the influence of a delayed wave can be curbed easily in a receiving process.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A receiving apparatus comprising:
a receiver for acquiring a signal from a sending apparatus that transmits a signal into which a guard interval which is a replica of at least part of an effective symbol is inserted between the effective symbol and another effective symbol; and
a timing detector for finding a correlation between the received signal acquired by the receiver and a signal obtained by shifting the received signal in a time direction, for detecting timing at which a maximum correlation value is obtained, and for determining that timing which is predetermined time (>0) away from the timing detected is a position of an effective symbol included in the received signal.

2. The receiving apparatus according to claim 1, wherein the timing detector determines the predetermined time on the basis of a frequency domain signal obtained by performing a Fourier transform on a known signal included in the received signal.

3. The receiving apparatus according to claim 2, wherein the timing detector:
finds a value which indicates a correlation between a first signal obtained by dividing the frequency domain signal obtained by performing a Fourier transform by a known frequency domain signal and a second signal obtained by shifting the first signal in a frequency direction by a predetermined frequency; and
determines the predetermined time on the basis of an angular component of the value.

4. The receiving apparatus according to claim 3, wherein the timing detector determines that timing obtained by shifting the timing detected forward or backward by the predetermined time according to the angular component of the value is the position of the effective symbol.

5. The receiving apparatus according to claim 3, wherein the timing detector sets the predetermined frequency to a spacing between subcarriers used for the received signal.

6. A receiving method comprising:
acquiring a signal from a sending apparatus that transmits a signal into which a guard interval which is a replica of at least part of an effective symbol is inserted between the effective symbol and another effective symbol; and
finding a correlation between the received signal acquired and a signal obtained by shifting the received signal in a time direction, detecting timing at which a maximum correlation value is obtained, and determining that timing which is predetermined time (>0) away from the timing detected is a position of an effective symbol included in the received signal.

7. A receiving apparatus comprising:
a receiver for acquiring a signal from a sending apparatus that transmits a signal into which a guard interval which is a replica of at least part of an effective symbol is inserted between the effective symbol and another effective symbol;
a timing detector for finding a correlation between the received signal acquired by the receiver and a signal obtained by shifting the received signal in a time direction and for detecting timing at which a maximum correlation value is obtained; and
an effective symbol extractor for finding an extraction interval in which an effective symbol length signal is extracted from the received signal on the basis of a result detected by the timing detector and for replacing a signal with predetermined length at an end of the extraction interval with a signal with the predetermined length which appears before the extraction interval.

8. A receiving method comprising:
acquiring a signal from a sending apparatus that transmits a signal into which a guard interval which is a replica of at least part of an effective symbol is inserted between the effective symbol and another effective symbol;
finding a correlation between the received signal acquired and a signal obtained by shifting the received signal in a time direction and detecting timing at which a maximum correlation value is obtained; and
finding an extraction interval in which an effective symbol length signal is extracted from the received signal on the basis of a result of the timing detection and replacing a signal with predetermined length at an end of the extraction interval with a signal with the predetermined length which appears before the extraction interval.
